(19) United States
(12) Patent Application Publication
(10) Pub. No.: US 2012/0094161 A1
(43) Pub. Date: Apr. 19, 2012

(54) SINGLE CELL AND BATTERY PACK COMPRISING THE SAME

(76) Inventor: Weixin ZHENG, Shenzhen (CN)

(21) Appl. No.: 13/282,818

(22) Filed: Oct. 27, 2011

Related U.S. Application Data
(63) Continuation of application No. PCT/CN2010/071862, filed on Apr. 18, 2010.

(30) Foreign Application Priority Data
Apr. 30, 2009 (CN) 200910107175.1

(51) Int. Cl. H01M 2/10; H01M 10/36; H01M 2/30

(52) U.S. Cl. 429/94; 429/179; 429/158

(57) ABSTRACT

The present invention discloses a single cell comprising a shell, a cover and an electric core. The cover is connected with the shell in a sealed manner. The electric core is accommodated in the shell, and at least two electrode terminals having the same polarity penetrate through the cover respectively. The present invention further discloses a power battery pack comprising a plurality of the single cells as described above.

### CROSS-REFERENCE TO RELATED APPLICATIONS

The present application is a continuation of International Application No. PCT/CN2010/071862, filed Apr. 18, 2010, designating the United States of America, which claims priority to Chinese Patent Application No. 200910107175.1, filed to the State Intellectual Property Office, P.R.C. on Apr. 30, 2009, the entire contents of both of which are incorporated herein by reference.

### FIELD OF THE INVENTION

The present invention relates to a battery, more particularly to a single cell with improved structure and a battery pack comprising the same.

### BACKGROUND

As batteries are more and more widely used nowadays, demand for enhanced battery performance is growing. Higher power output is required by recent equipment, such as an electric vehicle. Normally, a plurality of single cells are connected to form a power battery pack. Bolts and nuts of the single cells are commonly adopted to serve as positive and negative electrode poles, respectively which are connected in parallel and/or in series to form a desired power source with high power output.

However, this kind of connection may cause high internal resistance. That is to say, the current conducting area in the available space is limited, and the rate performance of the battery is restricted.

### SUMMARY OF THE INVENTION

The present disclosure is directed to solve at least one of the problems in the art. Accordingly, a single cell may need to be provided, which may meet high power discharge requirement and overcome safety defects in the art. Further, a single cell may need to be provided which may be capable of high rate discharge with enhanced safety and reliability.

Further, a power battery pack comprising the same may be provided.

According to an embodiment of the disclosure, a single cell may be provided, comprising: a shell with a first open end and a second open end; a first cover for sealing the first open end; a second cover for sealing the second open end; at least an electric core accommodated inside the shell having a positive tab and a negative tab; at least two positive electrode terminals, each having a first end portion conductively coupled to the positive tab and a second end portion extending through the first cover; and at least two negative electrode terminals, each having a first end portion conductively coupled to the negative tab and a second end portion extending through the second cover.

According to another embodiment of the disclosure, a power battery pack comprising a plurality of the single cells as described above may be provided, which may be connected in series, in parallel, or in parallel and the parallel-connected cells being connected in series.

There are a plurality of electrode terminals with the same polarity in a single cell, thus the current-conducting area is increased, and the rate discharging characteristics of the battery are enhanced. Especially for electric vehicles requiring batteries that maintain long time high rate discharging, the single cell and the power battery pack disclosed herein provide an enhanced solution.

Normally, a battery with high power output uses a plurality of tabs in a single cell to extract current, and then the electrode terminals are welded with the plurality of tabs. The higher the power output is, the more tabs are needed. Thus, the total thickness of the tabs connected with the electrode terminals becomes large, which makes it difficult to connect the electrode terminals with the tabs. Furthermore, the tabs are easily shed off, which may affect the current output, and at some time, may cause short circuit and other related problems.

According to the present disclosure, a plurality of electrode terminals of the same polarity may help to reduce the total thickness of the tabs. Thus it may be easier for ultrasonic or laser welding between the electrode terminals and tabs, and to realize high power output and the manufacture thereof. The battery capacity may be also improved without affecting battery performance. The present disclosure is especially suited for high capacity batteries with thick electric cores, because of easier welding. Even the thickness of the core may be properly increased to decrease the width of the electrode plates, thus ameliorating the problems of coiling, wrinkling of the separator and so on. Furthermore, the peripheral length of the single cell may be reduced so that the weight of the battery is also reduced.

Heat inside the battery due to large-current discharging and/or charging or abnormal discharging can be effectively dissipated through the plurality of electrode terminals, so that the safety and the large-current discharge performance of the battery are improved as well as the battery lifespan. In addition, the single cells are very convenient for connection, especially for power battery packs, thus enhancing the stability of a power vehicle in a bumping state.

### BRIEF DESCRIPTION OF THE DRAWINGS

These and other aspects and advantages of the invention will become apparent and more readily appreciated from the following descriptions taken in conjunction with the drawings in which:

FIG. 1 shows a partial perspective view of a single cell according to an embodiment of the present invention;

FIG. 2 shows a cross sectional view along A-A shown in FIG. 1;

FIG. 3 shows a perspective view of a single cell according to another embodiment of the present invention;

FIG. 4 shows a cross sectional view along B-B shown in FIG. 3;

FIG. 5 shows a cross sectional view of a single cell comprising three electrode terminals with the same polarity according to an embodiment of the invention;

FIG. 6A shows a plan view of a single cell in the prior art;

FIG. 6B shows a plan view of a periphery of a single cell having the same capacity as that shown in FIG. 6A according to an embodiment of the present invention;

FIG. 7 shows a schematic view of a battery pack according to an embodiment of the present invention where the electrical terminals in the single cells are butt jointed;

FIG. 8 shows a schematic view of a battery pack according to an embodiment of the present invention where the electrical terminals in the single cells are lap jointed;

FIG. 9 shows a schematic view of a battery pack according to an embodiment of the present invention where the electrical terminals in the single cells are flange butt jointed;

FIG. 10 shows a cross sectional view of a battery pack according to an embodiment of the invention where the electrical terminals in the single cells are bridge jointed;

FIG. 11a shows a front perspective view of a battery pack according to an embodiment of the present invention; and

FIG. 11b shows a rear perspective view of the battery pack shown in FIG. 11a.

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

### DESCRIPTION OF THE EMBODIMENTS

Reference will be made in detail to embodiments of the present invention. The embodiments described herein with reference to drawings are explanatory, illustrative, and used to generally understand the present invention. The embodiments shall not be construed to limit the present invention. The same or similar elements and the elements having same or similar functions are denoted by like reference numerals throughout the descriptions.

According to an embodiment of the disclosure, a single cell 1 may be provided, comprising: a shell with a first open end and a second open end; a first cover for sealing the first open end; a second cover for sealing the second open end; at least an electric core accommodated inside the shell having a positive tab and a negative tab; at least two positive electrode terminals, each having a first end portion conductively coupled to the positive tab and a second end portion extending through the first cover; and at least two negative electrode terminals, each having a first end portion conductively coupled to the negative tab and a second end portion extending through the second cover.

It should be noted that the structure described at either end of the single cell 1 may be adapted to both ends thereof, thus in the following description, only the structure at one end will be described for clarity purposes.

According to one embodiment of the present disclosure, the cover 2 is connected with the shell in a sealed manner, and the electric core 5 may be accommodated inside the shell. The electric core 5 may comprise a positive plate, a negative plate and a separator interposed therebetween. The electric core 5 may further comprise a positive tab and a negative tab for extracting current; the cover 2 may further comprise an electrode terminal 3 penetrating through the cover 2 for extracting current, the electrode terminal 3 may comprise a first end portion 31 in electric connection with the electric core 5 which is sealed in the shell, and a second end portion 32 located out of the shell for conducting current; the electrode terminal 3 may comprise a positive electrode terminal and a negative electrode terminal.

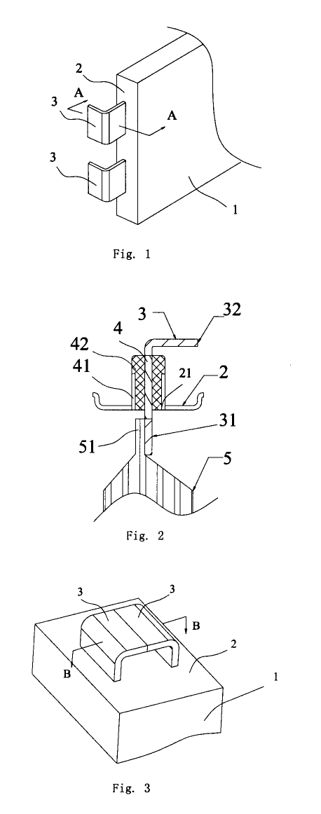

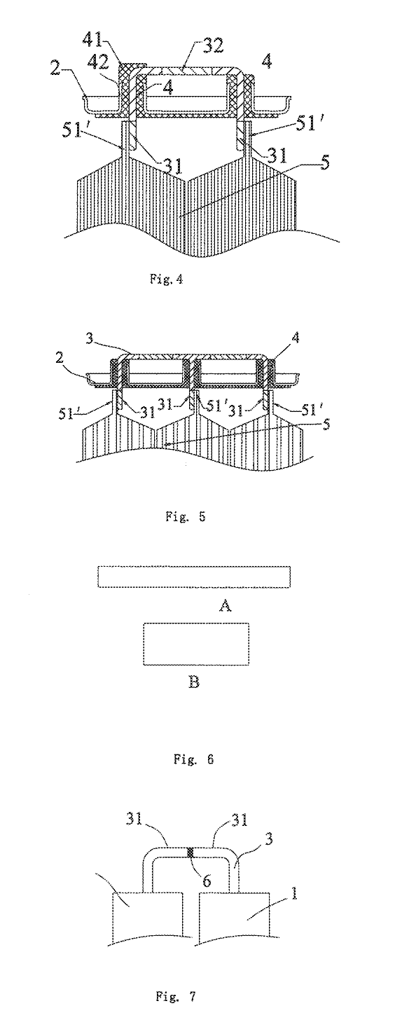

As shown in FIGS. 1, 2, two electrode terminals 3 with the same polarity are aligned straightly on an end of the single cell 1. The electrode terminal 3 with a 90 degree bending angle has a second end portion 32 penetrating through a via hole 21 of the cover 2 and extends out of the shell. The cover 2 may be sealed with the electrode terminal 3 via a sealing structure 4. The sealing structure 4 may comprise a hollow rivet 41 and an insulating elastic member 42. The electrode terminal 3 may be held by the insulating elastic member 42 and the rivet 41. The rivet 41 may press tightly against the insulating elastic member 42. The insulating elastic member 42 may extend beyond the hollow rivet 41, and wrap an upper portion of the hollow rivet 41 to form a flanged structure. The first end portion 31 of the electrode terminal 3 may be welded on a tab 51 of the electric core 5 via ultrasonic welding. In FIG. 1, two electrode terminals 3 may be arranged along a width direction of the tab 51 to share the current from the tab 51. The electric core 5 may have a coiled core structure. The width of the positive and negative electrode plates of the electric core 5 may be about 290 mm. The cross-section perimeter of the shell may be about 644 mm. By providing at least two electrode terminals 3 on the cover 2 and electrically connected with the tab 51, the conducting area for the single cell 1 may be increased and the rate performance may be enhanced accordingly.

The second end portions of the plurality of positive electrode terminals may extract current separately, or may form a connection to extract current. The connection may be formed by normal welding or other connecting methods. According to some embodiments, the second end portions of the positive electrode terminals may be connected to form an integrated structure, which can be understood as an integrated electrode terminal comprising a plurality of tabs connecting to the first end portions which extract the current.

There is no special limitation on the positional relationship between the positive electrode terminals or the negative electrode terminals. For easier connection, assembly and production, according to some embodiments of the disclosure, the electrode terminals with the same polarity are parallel with each other. The electrode terminals penetrate through the cover, and are arranged along the length direction of the cover or along the width direction. According to some embodiments, the electrode terminals penetrate through the cover and bend for easier connection and sealing as well as buffering direct forces. According to some other embodiments, the second portions of the electrode terminals penetrate out of the cover and may bend for one or more times. If the electrode terminals with the same polarity extract current separately, according to some embodiments, the bending direction of the electrode terminals may be the same, and more preferably, the electrode terminals with the same polarity are aligned in parallel on the cover.

The electrode terminals may be made of any conductive members known in the art, for example, bent conductive poles or sheets formed by one body casting, or conductive components formed by conductive members of various shapes welded in various methods. According to some embodiments, the electrode terminals are in a sheet shape. Preferably, the two ends of the electrode terminals are soft conductive sheets. More preferably, they are formed by overlapping or coiling a plurality of layers of conductive sheets, so that it is favorable for buffering the shock on the joint of the electrode terminals and on the sealing portions between the electrode terminal and the cover. The material for the electrode terminals may be various kinds of conductive materials known in the art, for example metal foil, Cu, Al, Ni, stainless steel, carbon steel, and Ni—Fe alloy. The size of the electrode terminals may vary according to practical requirements. According to some embodiments, because of the manufacturing process, the heating dissipation performance and so on, a rectangular parallelepiped shape may be adopted. When the electrode terminals have a sheet shape, the width of the electrode terminal may be about 1-90 of that of the shell, and the thickness of the electrode terminal may be about 5-90 of that of the shell. That means, if the size of the cell is 58 mm×150 mm×400 mm, the thickness of the electrode terminal may be about 2-6 mm, the width about 40-60 mm, and the length about 20-40 mm.

Each of the positive plate and the negative plate may have a dressed region and an undressed region. The dressed region has been coated with an active material. An end parallel with the length direction of the electrode plate may have an undressed region with certain width. The undressed region may be specially reserved when the active material is coated on the plate, or it may be formed by scraping the dressed area. The active material may be any kinds of active materials for anode or cathode known in the art. The coating or scraping process may be any method known in the art. The preparation method of the plate may be any method known in the field. According to some preferred embodiments, the electrode core may be formed by coiling the positive plate, the negative plate and the separator interposed in between along the length direction of the separator. To improve the safety performance of the battery, according to an embodiment of the disclosure, the outer layer of the core after coiling may be the separator. The positive tab and the negative tab may be any tabs known in the art. One or more tabs may be welded on the positive electrode plate and the negative electrode plate respectively. According to some embodiments, the positive and negative tabs are formed by directly coiling and compressing the undressed region. The tabs may be extended from two ends of the cell core, or may be extended from just one end. According to some embodiments, the positive tabs and the negative tabs are reversely placed, and extend beyond the separator interposed between the positive plate and the negative plate.

Meanwhile, according to some embodiments, the width of the positive plate and the negative plate may be about 10-110 mm; more preferably 40-60 mm. The width provided above may help to reduce the difficulty of coiling and wrinkling of the separator, and may decrease the cross-section perimeter of the cell shell. According to some embodiments, the cross-section perimeter of the cell shell may be about 30-600 mm, more preferably about 260-400 mm. In this case, it will be beneficial for decreasing the weight of the cell, but with the same capacity. It is of special importance for the mobile equipments such as electric vehicles which require a plurality of cells to provide electricity. According to the above embodiments of the disclosure, with the same capacity, the battery provided may decrease the weight of the battery, simplify welding and production, and improve the yield rate. Also the above mentioned cell may realize high power discharge and enhance the safety performance.

One end of the cell shell may be formed with a cover having a via hole. The positive electrode terminal or the negative electrode terminal has one end penetrating through the via hole and extending out of the shell. When the tabs are extended from both ends of the electrode core, according to some embodiments, the positive electrode terminals and the negative electrode terminals may be extended from each end of the shell respectively, to conduct current from each end of the cell. The material for the insulating elastic member in the sealing structure may be any kind of sealing and insulating material, for example plastics, rubber, resin, glass, and ceramic, which may be insulating, organic solvent and HF acid proof, and attached with metal materials. The preparation method of the insulating elastic member may be any process known in the art, such as injection molding.

To improve the safety of the single cell, according to some other embodiments of the present disclosure, the joint of the negative tab with the negative terminal as well as the joint of the positive tab with the positive terminal has an insulating ring respectively. The insulating ring may be any conventional insulating ring known in the art, such as a rubber or a plastic ring. The electrode terminals may be connected with the tabs with the same polarity along the width direction of the tabs, which means the electrode terminals with the same polarity may be connected with and extract current from the same tab. In this way, the current and heat may be distributed over at least two electrode terminals with the same polarity, improving the rate discharging performance and the safety performance. Especially for the plurality of tabs, the electrode terminals with the same polarity may be also connected along the thickness direction of the tab groups, and share the thin tab groups. Thus, the problem of thick tab groups being difficult to weld may be solved for batteries with high capacity and high current discharging. The electrode terminal and the tab may be easily connected by ultrasonic welding or laser welding and so on, which may be easier to realize and produce.

The present disclosure further provides a power battery pack comprising a plurality of cells as described above, and the plurality of cells are connected in parallel or in series, or in parallel and the parallel-connected cells being connected in series. The connection between the single cells may be realized by butt jointing, bridge jointing, lap jointing or flange butt jointing. The connection method may be welding and/or adhering. The welding method may be ultrasonic welding, laser welding, braze welding, flash welding, friction welding, resistance welding and so on. According to some embodiments, laser welding may be preferable. The at least two positive or negative terminals penetrate through the cover and bend accordingly. The connected positive or negative electrode terminals may bend one or more times. For some embodiments when the second end portions of the electrode terminals with the same polarity are connected into an integrated structure, bridge connection of the electrode terminals may be adopted. Here, bridge connection means that in between the electrode terminals, there may be a conductive member for conducting the current between the cells. There may be no special limit for the material of the conductive member. According to some embodiments, to reduce the resistance, the conductive member may have the same material with the electrode terminal.

According to another embodiment of the disclosure as shown in FIG. 3 and FIG. 4, two parallel electrode terminals 3 with the same polarity are provided on one end of the cell 1. The second end portion 32 of the electrode terminal 3 with a 90 degree bending angle penetrates through the via hole on the cover 2 and extends out of the shell. The second end portions 32 of the two electrode terminals 3 are connected as one body structure as shown in FIG. 3. A sealing structure 4 may be adopted to seal the joint of the cover 2 and the electrode terminal 3. The sealing structure 4 may comprise a rivet 41 and an insulating elastic member 42. The electrode terminal 3 may be in turn held by insulating elastic member 42 and then the rivet 41, and the rivet 41 may press tightly against the insulating elastic member 42. The insulating elastic member 42 extends beyond the hollow rivet 41 and wraps the upper portion of the hollow rivet 41 forming a flanged structure. The first end portion 31 of the electrode terminal 3 may be welded to the tabs of the electric core 5 via ultrasonic welding. The two electrode terminals 3 may be arranged along the thickness direction of the tab groups. Each electrode terminal 3 may be separately welded with part 51′ of the tabs to conduct the current accordingly. The electric core 5 may have an overlapped core structure. The width of the positive and negative electrode plates may be about 145 mm, and the cross-section perimeter of the cell shell may be about 406 mm. With at least two electrode terminals 3 on the cover 2 electrically connected with the tabs, the conducting area for the cell may be increased and the rate performance may be enhanced; meanwhile the welding thickness with the tabs may be decreased which may be beneficial for manufacture.

FIG. 5 shows a cross sectional view of a single cell comprising three electrode terminals with the same polarity according to an embodiment of the disclosure.

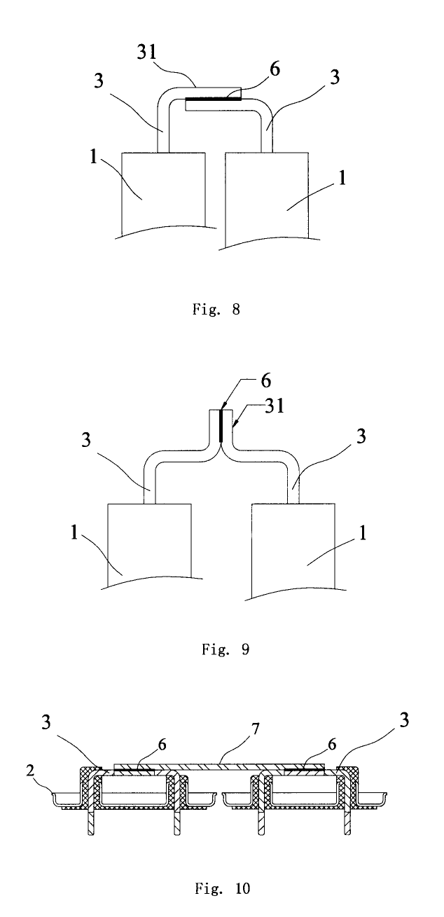

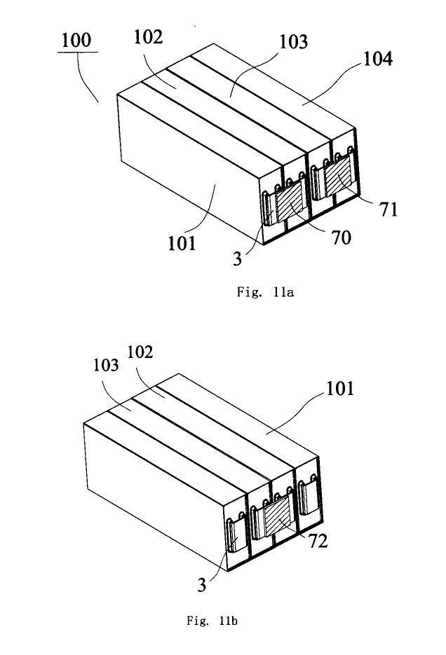

As shown in FIG. 7, FIG. 8 and FIG. 9, the second end portions 32 of the electrode terminals 3 in the single cells 1 may be connected by butt jointing, lap jointing, or flange butt jointing to form a connecting portion 6.

FIG. 10 shows a cross sectional view of a battery pack according to an embodiment of the invention where the electrical terminals 3 are bridge jointed. As shown in FIG. 10, the second end portions 32 of the electrode terminals 3 in the single cells 1 may be bridge connected via a conductive sheet 7, so that the conductive sheet 7 forms a connecting portion 6 with the electrode terminals 3. FIG. 11 shows a power battery pack comprising the single cells 1 as described above. In FIG. 11, the electrode terminals are bridge jointed so that the single cells 1 may be connected in parallel, in series, or in parallel and the parallel-connected cells being connected in series accordingly.

FIGS. 11a and 11b show a front and a rear perspective views of a battery pack 100 according to an embodiment of the present invention where single cells 101, 102, 103 and 104 are connected in series respectively. As shown in FIGS. 11a and 11b, the electrode terminals 3 in the single cells 1 may be bridge connected via conductive sheets 70, 71 and 72. As shown in FIG. 11a, the electrode terminals 3 of the single cells 101 and 102 are bridge connected, and the electrode terminals 3 of the single cells 103 and 104 are bridge-connected. As shown in FIG. 11b, the electrode terminals 3 of the single cells 102 and 103 are bridge connected, so that the single cells 101, 102, 103 and 104 are connected in series. However, it should be noted that the single cells may be connected in parallel, or in parallel and the parallel-connected cells being connected in series. Therefore, the description thereof is for illustration purpose rather than limitation.

Although explanatory embodiments have been shown and described, it would be appreciated by those skilled in the art that changes, alternatives, and modifications can be made in the embodiments without departing from spirit and principles of the invention. Such changes, alternatives, and modifications all fall into the scope of the claims and their equivalents.

What is claimed is:

1. A single cell comprising:
a shell with a first open end and a second open end;
a first cover for sealing the first open end;
a second cover for sealing the second open end;
at least an electric core in the shell having a positive tab and a negative tab;
at least two positive electrode terminals, each having a first end portion conductively coupled to the positive tab and a second end portion extending through the first cover; and
at least two negative electrode terminals, each having a first end portion conductively coupled to the negative tab and a second end portion extending through the second cover.

2. The single cell of claim 1, wherein the second end portions of the positive electrode terminals are connected to each other; and/or
the second end portions of the negative electrode terminals are connected to each other.

3. The single cell of claim 1, wherein there is a plurality of electric cores, the positive electrical terminals are aligned in a thickness direction of the positive tabs, and the first end portions of the positive electrical terminals are conductively coupled to the positive tabs and parallel with each other;
and wherein the negative electrical terminals are aligned in a thickness direction of the negative tabs, and the first end portions of the negative electrical terminals are conductively coupled to the negative tabs and parallel with each other.

4. The single cell of claim 1, wherein the positive electrode terminals are aligned in a width direction of the positive tab, and the first end portions of the positive electrical terminals are conductively coupled to the positive tab; and
wherein the negative electrode terminals are aligned in a width direction of the negative tab, and the first end portions of the negative electrical terminals are conductively coupled to the negative tab.

5. The single cell of claim 1, wherein the shell is rectangular parallelepiped, the electrode terminals are formed with a sheet shape, the width of the electrode terminals are about 5-90 of the width of the single cell, and the thickness of the electrode terminals are about 1-90 of the thickness of the single cell.

6. The single cell of claim 1, wherein the electric core comprises a positive plate, a negative plate and a separator interposed therebetween which are coiled together, and each of the positive plate and the negative plate has a dressed area and an undressed area at an end of the dressed area, with the dressed area coated with active material as an electrode and the undressed area as a tab with respective polarities, the positive tab and the negative tab extending beyond the separator in an opposite direction.

7. The single cell of claim 6, wherein the positive plate and negative plate have a width of about 10-110 mm, and
the shell has a cross section with a perimeter of about 30-600 mm.

8. The single cell of claim 6, wherein the first cover are formed with a first set of via holes with each positive electrode terminal penetrating through each via hole via a first sealing structure comprising a first hollow rivet and a first insulating elastic member with each positive electrode terminal fixed therein, the first hollow rivet being integrally formed with the first cover, and the first insulating elastic member being disposed within the first hollow rivet and tightly wrapping around an open end of the first hollow rivet; and
wherein the second cover are formed with a second set of via holes with each negative electrode terminal penetrating through each via hole via a second sealing structure comprising a second hollow rivet and a second insulating elastic member with each negative electrode terminal fixed therein, the second hollow rivet being integrally formed with the second cover, and the second insulating elastic member being disposed within the second hollow rivet and tightly wrapping around an open end of the second hollow rivet.

9. The single cell in claim 1, wherein the joint of the negative tab with the negative terminal and the joint of the positive tab and the positive terminal are sealed respectively by insulating rings.

10. A power battery pack comprising a plurality of the single cells according to claim 1 which are connected in parallel or in series, or in parallel and the parallel-connected cells being connected in series.

11. The power battery pack in claim 10, wherein the single cells are connected in parallel or in series, or in parallel and the parallel-connected cells being connected in series, by butt jointing, lap jointing or flange butt jointing of the second end portions of the positive and negative electrode terminals respectively.

12. The power battery pack in claim 10, wherein the second end portions of the positive electrode terminals in each single cell are integrally connected with each other, the second end portions of the negative electrode terminals in each single cell are integrally connected with each other, and the positive electrode terminals and negative electrode terminals of the single cells are connected with each other respectively via conductive members so that the single cells are connected in parallel or in series, or in parallel and the parallel-connected cells being connected in series.
